(19) United States
(12) Patent Application Publication
(10) Pub. No.: US 2012/0166033 A1
(43) Pub. Date: Jun. 28, 2012

(54) METHOD AND APPARATUS FOR DETECTING DRIVING INFORMATION OF AUTONOMOUS DRIVING SYSTEM

(75) Inventors: Jaemin BYUN, Daejeon (KR); Myung Chan ROH, Daejeon (KR); Junyong SUNG, Daejeon (KR); Sung Hoon KIM, Daejeon (KR)

(73) Assignee: Electronics and Telecommunications Research Institute, Daejeon (KR)

(21) Appl. No.: 13/334,671

(22) Filed: Dec. 22, 2011

(30) Foreign Application Priority Data
Dec. 23, 2010 (KR) 10-2010-0133782

(51) Int. Cl. G05D 1/02; G08G 1/00

(52) U.S. Cl. 701/23; 701/117

(57) ABSTRACT

A driving information detection apparatus of a vehicle includes: an image photographing unit for take a photograph of an image of a driving road; a lane information detecting unit; a road environment information detecting unit; a coordinate converting unit for converting a camera coordinates system of a detection result of the lane information detecting unit and the road environment detecting unit into a world coordinates system. The apparatus further includes a driving information detecting unit for applying an one dimensional straight line modeling to a converted result of the coordinate converting unit and detecting an driving information according to a result of the modeling.

### CROSS-REFERENCE(S) TO RELATED APPLICATION(S)

The present invention claims priority of Korean Patent Application No. 10-2010-0133782, filed on Dec. 23, 2010, which is incorporated herein by reference.

### FIELD OF THE INVENTION

The present invention relates to an autonomous driving system in road environment; and more particularly, to a method and an apparatus for detecting driving information of an autonomous driving system which are suitable for detecting driving information, e.g., lane information (stop line, centerline, crosswalk line and the like) and road environment information (road surface, road sign) and the like from image information obtained from multiple cameras installed in the autonomous driving system.

### BACKGROUND OF THE INVENTION

Environment and space detecting function is necessary for an autonomous driving system. In addition, the behavior of a robot in the autonomous driving system should be determined according to road surface signs expressed for a safe driving in the autonomous driving system in the outside road environment. Especially, a lane plays role of boundary line for preventing the autonomous system running on a road from breaking away between a road and a sidewalk and thus, various technologies for detecting the shape of the road and the location and position of a vehicle on a road through lane detection have been developed.

Conventional lane detection technologies detect mostly both lanes by using a single camera. In case that viewing angle for the target objects of long distance and short distance is obtained by using the single camera, detection errors such as the distortion of the wide angle lens of the camera and noise due to nonuniform lighting can be occurred.

In addition, there is a method for generating image information by synthesizing image information of the front and the side of a vehicle taken by a plurality of cameras and detecting a lane based on the image information. In case of the method, the synthesized image can be partially distorted according to the performance and the installation method of the camera.

### SUMMARY OF THE INVENTION

The present invention provides a driving information detection technique of an autonomous driving system capable of solving problems occurring in camera based sign detection techniques by integrating various information, e.g., existing road information, and a result detected at a camera by using location detection and digital map and applying a probability technique.

The present invention further provides the driving information detection technique of an autonomous driving system capable of detecting driving information more accurately by detecting a sign on the road surface obtained by multiple cameras having a plurality of angles and applying a sensor convergence method using location detection on digital road map.

In accordance with an aspect of the present invention, there is provided a driving information detection apparatus of an autonomous driving system. The apparatus includes: an image photographing unit for take a photograph of an image of a driving road; a lane information detecting unit for detecting lane information from the image of the image photographing unit; a road environment information detecting unit for detecting road environment information from the image of the image photographing unit; a coordinate converting unit for converting a camera coordinates system of a detection result of the lane information detecting unit and the road environment detecting unit into a world coordinates system; and a driving information detecting unit for applying an one dimensional straight line modeling to a converted result of the coordinate converting unit and detecting an driving information according to a result of the modeling.

In accordance with another aspect of the present invention, there is provided a method for driving information of an autonomous driving system. The method includes: obtaining a left photograph and a right photograph of a driving road; detecting left lane information and right lane information from the left photograph and the right photograph; detecting road environment information from a center image of the driving road; converting a camera coordinates system of the left lane information, the right lane information and a detected result of the road environment into a world coordinates system; and applying an one dimensional straight line modeling to a converted result of the world coordinates system and detecting driving information according to a result of the modeling.

### BRIEF DESCRIPTION OF THE DRAWINGS

The objects and features of the present invention will become apparent from the following description of embodiments, given in conjunction with the accompanying drawings, in which:

FIG. 1 shows a block diagram of a driving information detection apparatus of an autonomous driving system in accordance with an embodiment of the present invention;

FIG. 2 illustrates an example of the autonomous driving system in which a first to a third image photographing unit installed;

FIG. 3 is a flowchart of a method for detecting a driving information of the autonomous driving system in accordance with the embodiment of the present invention; and

FIG. 4 depicts a specific flowchart of a lane detecting process of the method for detecting driving information in FIG. 3.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

In order that an autonomous driving system in the outside road environment, e.g., an autonomous driving robot can perform autonomous driving, the autonomous driving robot should drive in a road by distinguishing between road area and non-road area through lane information detection and determine a driving method according to driving situation and driving environment by detecting road environment (road sign and the like) on a road surface.

Target objects to be detected on a road surface includes road signs, e.g., a lane, a stop line, a speed bump and a crosswalk line.

In accordance with the embodiment of the present invention, more powerful driving information detection environment in various lighting and weather can be implemented by taking a photograph of a target object on a road with multiple cameras. For example, it will be provided to driving information detection technique by which the color and location of a lane can be detected by varying the angle of view and sight distance of front and side camera through a multi camera even when dead zone and noise occurs.

Hereinafter, embodiments of the present invention will be described with reference to the accompanying drawings which form a part hereof.

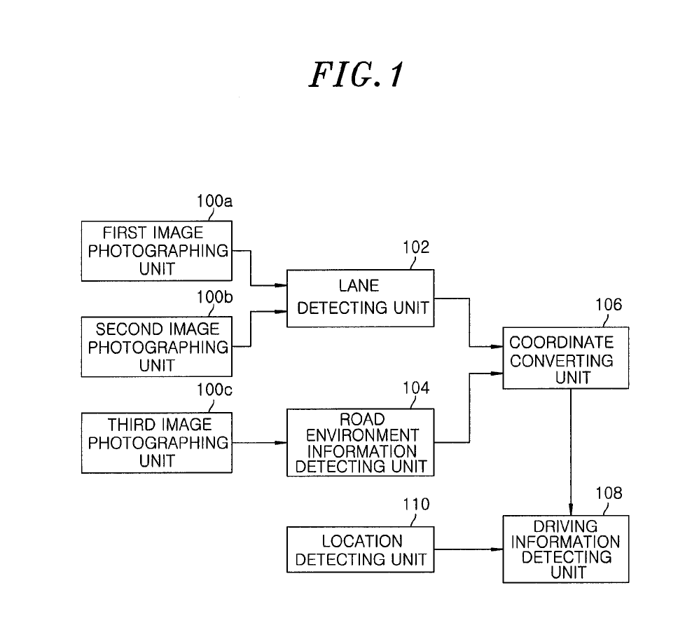

FIG. 1 shows a block diagram of a driving information detection apparatus of an autonomous driving system in accordance with the embodiment of the present invention. The apparatus for detecting driving information includes a first image photographing unit 100a, a second image photographing unit 100b, a third image photographing unit 100c, a lane information detecting unit 102, a road environment information detecting unit 104, a coordinate converting unit 106, a driving information detecting unit 108 and a location detecting unit 110.

As shown in FIG. 1, the first image photographing unit 100a may take a photograph of image on a road, e.g., left lane, when driving the autonomous driving system and the second image photographing unit 100b may take a photograph of image on a road, e.g., right lane when driving the autonomous driving system.

In addition, the third image photographing unit 100c may take a photograph of image on a road, e.g., the center surface of a road, when driving the autonomous driving system.

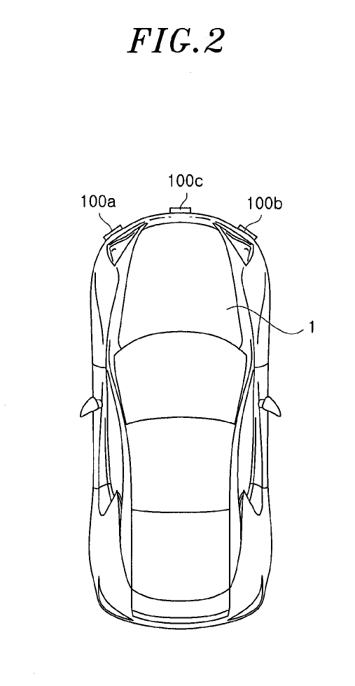

The first to third image photographing units 100a to 100c may include a camera and be installed in the front side of the autonomous driving system as shown in FIG. 2.

Specifically, the autonomous driving system of FIG. 2 is an autonomous driving vehicle 1. The first image photographing unit 100a is installed on the left front side of the autonomous driving vehicle 1 and can take a picture of left lane when driving the autonomous driving vehicle 1.

In addition, the second image photographing unit 100b is installed on the right front side of the autonomous driving vehicle 1 and can take a picture of right lane when driving the autonomous driving vehicle 1.

Furthermore, the third image photographing unit 100c is installed on the center of the autonomous driving vehicle 1 and can take a picture of the center surface of a road when driving the autonomous driving vehicle 1.

Referring to FIG. 1 again, the lane information detecting unit 102 detects a left lane and a right lane from images on road which are taken by the first image photographing unit 100a and the second image photographing unit 100b.

The road information environment detecting unit 104 can detect road environment information from image taken by the third image photographing unit 100c. Here, the road environment information can be road surface information, road sign information and information for both lanes.

The coordinate converting unit 106 converts camera coordinates system of the left lane information and the right lane information detected by the lane information detecting unit 102 into world coordinates system. In addition, the coordinate converting unit 106 may convert road surface information, e.g., stop line information, speed bump information, road sign information and the like and the camera coordinates system of both lanes detected by the road environment information detecting unit 104.

The driving information detecting unit 108 may apply one dimensional straight line modeling to the converted result of the coordinate converting unit 106 and calculate a distance between a road sign and the autonomous driving vehicle 1 according to a location detection result provided from the location detecting unit 110. The driving information detecting unit 108 can detect and output driving information according to the modeling result and the calculated distance.

The location detecting unit 110 detects the location of the autonomous driving vehicle 1 and provides the location detection result to the driving information detecting unit 108.

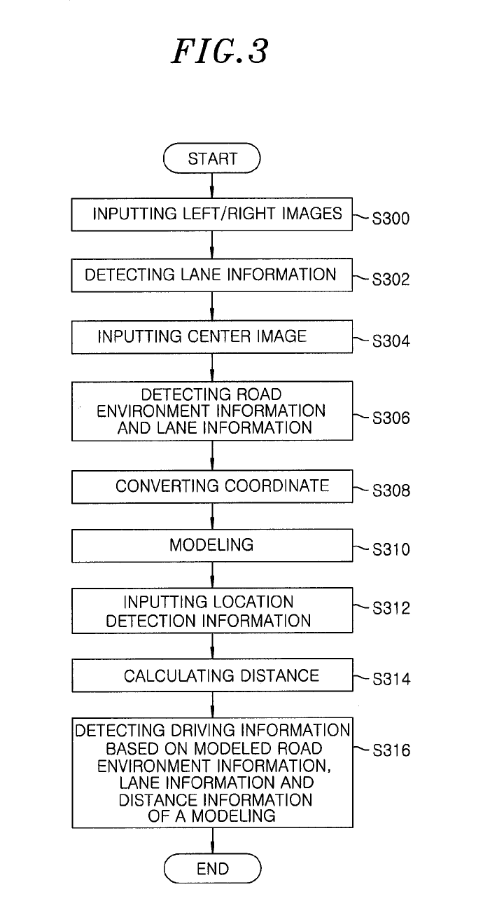

Hereinafter, a driving information detecting method of an autonomous driving system in accordance with the embodiments of the present invention will be described with reference to the following FIG. 3.

As shown in FIG. 3, when left and right images are inputted from the first image photographing unit 100a and the right image photographing unit 100b in step S300, the lane information detecting unit 102 may detect left lane information from the left image and right lane information from the right image in step S302.

In addition, the road environment information detecting unit 104 is inputted with a center image from the third image photographing unit 100c in step S304 and detects road environment information and information for both lanes from the center image in step S306. Here, the road environment information includes road surface information and road sign information and the information for both lanes includes left lane information and right lane information.

Thereafter, the coordinate converting unit 106 may covert camera coordinates system inputted from the lane information detecting unit 102 and the road environment detecting unit 104 into world coordinates system and provide the driving information detecting unit 108 with the converted result in step S308.

The driving information detecting unit 108 applies one dimensional straight line modeling to the converted result inputted from the coordinate converting unit 106 in step S310, calculates a distance between a road sign and the autonomous driving vehicle 1 based on location detection information obtained from the location detecting unit 110 in step S312 and S314. The driving information detecting unit 108 detects and outputs driving information according to the modeling result and the result of the distance calculation in step S316.

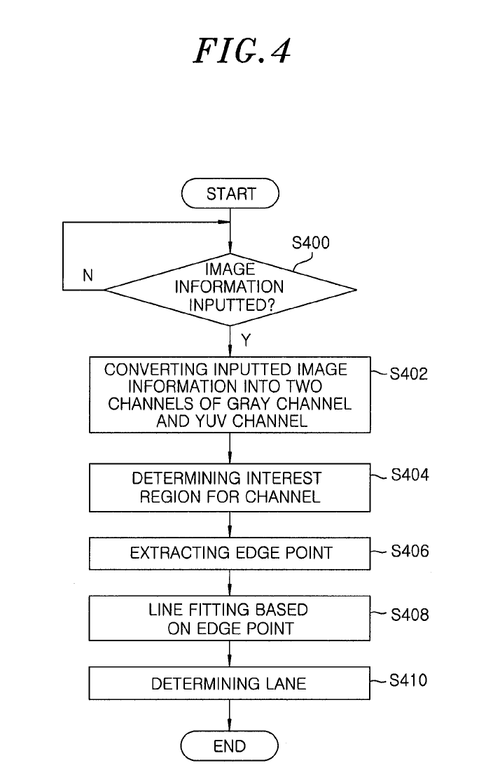

FIG. 4 depicts an exemplary specific flowchart of a lane detecting process of FIG. 3.

As shown in FIG. 4, if image information, e.g., color image information is inputted by camera, i.e., the first to third image photographing units 100a to 100c in step S400, the inputted image information can be converted into two channels, e.g., gray channel and YUV channel in step S402. The reason why the image information is converted into two channels is for detecting road surface information, e.g., the color and the shape of the road sign.

Next, an interest region for the channel converted information can be determined by considering process speed and work efficiency in step S404. The determination of the interest region is for enhancing the quality of image by performing image improvement process such as noise removal in the corresponding area.

Thereafter, edge is detected based on the image information of the gray channel. Herein, edge point having a lane shape may be extracted by performing combination and separation process between edges through clustering technique in step S406.

Next, final lane is determined by performing line fitting process based on the edge point through Hough transform based and extracting lines similar to lane shape in steps S408 and S410.

Meanwhile, an updating process for the reliability of each algorithm according to environment can be included. The updating process for the reliability of each algorithm can be performed by probability method based on result extracted from driving road information obtained by current location detection on a map of the autonomous driving vehicle, lane information and each road sign information obtained from the above described processes. Through this process, camera detection problems which can occur in various lighting and weather can be solved.

As described above, according to the embodiment of the present invention, an autonomous driving system can be powerful for various lighting and weather environment by installing multi camera into the autonomous driving system. In addition, more enhanced driving information detection result can be obtained by integrating various information, i.e., road information and a result detected from camera through a probability sensor fusion method.

While the invention has been shown and described with respect to the embodiments, it will be understood by those skilled in the art that various changes and modification may be made without departing from the scope of the invention as defined in the following claims.

What is claimed is:

1. A driving information detection apparatus of an autonomous driving system, comprising:
an image photographing unit for take a photograph of an image of a driving road;
a lane information detecting unit for detecting lane information from the image of the image photographing unit;
a road environment information detecting unit for detecting road environment information from the image of the image photographing unit;
a coordinate converting unit for converting a camera coordinates system of a detection result of the lane information detecting unit and the road environment detecting unit into a world coordinates system; and
a driving information detecting unit for applying an one dimensional straight line modeling to a converted result of the coordinate converting unit and detecting an driving information according to a result of the modeling.

2. The apparatus of claim 1, further comprising a location detecting unit for detecting a location of the autonomous driving system and providing the driving information detecting unit with a location detection result.

3. The apparatus of claim 2, wherein the driving information detecting unit calculates a distance between a road sign and the autonomous driving system based on the location detection result provided from the location detecting unit, detects and outputs driving information according to the calculation a result of the distance and the result of the modeling.

4. The apparatus of claim 1, wherein the image photographing unit includes:
a first image photographing unit for taking a photograph of a left image of the driving road;
a second image photographing unit for taking a photograph of a right image of the driving road; and
a third image photographing unit for taking a photograph of a center image of the driving road.

5. The apparatus of claim 1, wherein the lane information includes a left lane and a right lane of the driving road.

6. The apparatus of claim 1, wherein the road environment information includes at least one of road surface information, road sign information and lane information.

7. The apparatus of claim 1, wherein the lane information detecting unit converts the image of the image photographing unit into two channels and determines a interest region for the converted two channels.

8. The apparatus of claim 7, wherein the two channels includes a gray channel and a YUV channel.

9. The apparatus of claim 8, wherein the lane information detecting unit detects an edge point of a lane shape based on an image information of the gray channel.

10. The apparatus of claim 9, wherein the lane information detecting unit performs a line fitting process based on the edge point by using a Hough transform.

11. A method for driving information of an autonomous driving system, comprising:
obtaining a left photograph and a right photograph of a driving road;
detecting left lane information and right lane information from the left photograph and the right photograph;
detecting road environment information from a center image of the driving road;
converting a camera coordinates system of the left lane information, the right lane information and a detected result of the road environment into a world coordinates system; and
applying an one dimensional straight line modeling to a converted result of the world coordinates system and detecting driving information according to a result of the modeling.

12. The method of claim 11, further comprising:
obtaining a location detection information on a map of the driving road;
calculating a distance between a road sign and the autonomous driving system based on the obtained location detection information; and
detecting the driving information based on the result of the modeling and the calculated distance.

13. The method of claim 11, wherein the detecting the left lane information and the right lane information includes
converting an inputted image information into two channels;
determining an interest region for the converted two channels;
extracting an edge point of an lane shape by detecting an edge based an image information of one channel of the two channels; and
performing an line fitting process based on the edge point.

14. The method of claim 13, wherein the two channels includes a gray channel and a YUV channel.

15. The method of claim 14, wherein the one channel is the gray channel.

16. The method of claim 13, wherein the converting the inputted image is for detecting a color and a shape of a road surface information.

17. The method of claim 13, wherein the determining the interest region includes removing a noise.

18. The method of claim 13, wherein performing the line fitting process uses a Hough transform.

19. The method of claim 11, wherein the road environment information includes at least one of road surface information, road sign information and lane information.

20. The method of claim 11, further comprising updating the detected driving information through a probability method.
